(19) United States
(12) Patent Application Publication
(10) Pub. No.: US 2005/0096407 A1
(43) Pub. Date: May 5, 2005

(54) Self-polishing anti-fouling compositions

(76) Inventors: Revathi R. Tomko, North Olmsted, OH (US); Dino D. Papagianidis, Willowick, OH (US); John A. Joecken, Richfield, OH (US); James M. Reuter, Cleveland Heights, OH (US)

Correspondence Address: The Sherwin-Williams Company, 11 Midland Bldg. - Legal Dept., 101 Prospect Avenue, N.W., Cleveland, OH, 44115, US

(21) Appl. No.: 10/967,523

(22) Filed: Oct. 18, 2004

Related U.S. Application Data
(60) Provisional application No. 60/513,706, filed on Oct. 23, 2003.

(51) Int. Cl. C08K 3/00

(52) U.S. Cl. 523/122

(57) ABSTRACT

The invention is a self-polishing antifouling coating composition that comprises at least one biocidally active material; and a polymer binder, wherein the polymer binder is a film-forming, alkyd-stabilized non-aqueous dispersion having an acrylic core and a nonvolatile material content greater than 75%.

### CROSS-REFERENCE TO RELATED APPLICATION

This application claims the benefit of U.S. provisional patent application No. 60/513,706 filed on Oct. 23, 2003, the entirety of which is hereby incorporated by reference.

### BACKGROUND

Marine fouling is the settlement and growth of marine organisms like plants, animals and slime on underwater structures, ship hulls and cooling water intake lines in power plants. Marine fouling increases the weight of underwater structures, weakens them, and increases corrosion. It also increases the surface roughness of ship hulls, increases the drag, reduces the speed, and increases fuel consumption, operating costs and corrosion. Marine fouling can clog water intake lines in power plants and lead to shut down. It is necessary to have good coatings to prevent fouling. Marine fouling is complicated because twelve well-defined zones in the oceans of the world have been identified that differ in salinity, clarity, nature, and amount of micronutrients. The numbers and types of native fouling organisms differ from zone to zone. Barnacles, mussels, and bryozoans cause hard fouling. Algae, slime, tunicates, diatoms, bacteria, and hydroids cause soft fouling. The adhesives used by these fouling organisms are all different. Algaecides and fungicides generally kill soft fouling while molluscicides are effective against hard fouling. It should also be noted that the classification of a compound as a molluscicide does not guarantee its effectiveness against marine hard fouling. A compound effective against one type of species in one part of the world may not be effective against other species. Challenges also exist in making stable antifouling coatings, since many antifouling compounds are not compatible with the coating ingredients and binder systems.

For an antifouling coating to be effective over a long period of time, the biocide should have broad spectrum activity over various types of fouling in different waters and climatic conditions. The coating needs to have low water solubility so that it will release slowly at a steady rate during the lifetime of the coating. Ideally, the delivery system of the coating needs to have a controlled erosion rate so that it will erode gradually and carry the biocide with it. Delivery systems currently used in marine antifouling coatings are based on ablative, insoluble matrix, non-toxic foul release, and self-polishing technologies.

Ablative coatings are based on rosin as the binder. Rosin is a hard brittle resin which is very slightly soluble in seawater. Rosin-based antifouling paints have been referred to as soluble matrix or eroding paints. Typically, at a pH of 8.00, rosin dissolves in seawater, leaching out cuprous oxide and biocide. Surfaces of ablative paints become rough after time due to the formation of an uneven leached layer on the coating surface. This is due to non-uniform erosion. The biocides can get trapped underneath the leached layer and may not be available. These systems typically last from 1 to 3 years.

Insoluble matrix coatings are based on binders that are insoluble in seawater like the epoxies and vinyl resins. They typically contain cuprous oxide which leaches out and leaves a porous skeleton. The release rate of cuprous oxide decreases as the pores slowly get plugged with fouling. These coatings last from 1 to 2 years.

The non-toxic foul release coatings are based on silicone elastomers that have a low surface energy and a hydrophobic surface. Marine foulants stick weakly to them and are removed when the ship moves at speeds of 20 to 30 knots. The fouling can also be removed in some cases by low pressure washing. These non-toxic foul release coatings do not contain a biocide, and tend to be soft and easily damaged.

Self-polishing coatings generally comprise binders which are copolymers that, upon hydrolysis, release a biocide. The copolymers remaining after loss of the water soluble biocide slowly self polish. This uniform dissolution of the copolymers also helps keep the surface of the coating smooth. The first self-polishing system ever used was based on a tin polymer such as an organotin acrylate bound to the polymer backbone. While undergoing a controlled hydrolysis at a pH of 8.00, an organotin oxide is released that kills soft fouling. The polymer backbone that results is hydrophilic and slowly dissolves in seawater. Such coatings are undesirable due to the presence of the hydrolysable organotin moiety. Other self-polishing systems incorporate a cuprous oxide dispersed in a binder having a slowly hydrolysable component. Since the hydrolysis and dissolution occurs at the surface in a controlled manner, release of the tin oxide and cuprous oxide is uniform, enabling these coatings to last up to five years. However, these biocides are particularly problematic since they can cause contamination of the seawater and environment and kill non-target organisms. With the IMO (International Maritime Organization) ban on tin in 2005, these systems will soon become obsolete. Other self-polishing systems have been based on copper acrylate and zinc acrylate bound to the polymer backbone. However, these coatings are formulated with cuprous oxide in the paint formulations, and are thus classified as heavy-metal based.

The major disadvantage to the prior art antifouling systems is the use of common heavy-metal antifouling biocides containing organotin compounds, or copper (such as cuprous oxide), antimony and bismuth compounds.

An object of this invention is to provide improved self-polishing antifouling coatings comprising a novel binder, and having a non-volatile materials content greater than 80%. It is another object of this invention is to provide improved self-polishing antifouling coatings that are free of heavy metal biocides, as well as free of organotins. The self-polishing antifouling coatings comprise nonaqueous dispersions as binders based on acrylic polymer dispersions stabilized by alkyds having non-volatile material contents greater than 75% and at least one heavy metal free biocide.

### SUMMARY OF THE INVENTION

The invention is a self-polishing antifouling coating composition that comprises:
a) at least one biocidally active material; and
b) a polymer binder, wherein the polymer binder is a film-forming, alkyd-stabilized non-aqueous dispersion having an acrylic core and a nonvolatile material content greater than 75%;
wherein the biocidally active material is an antifouling biocide.

### DETAILED DESCRIPTION OF THE INVENTION

This invention is directed to a marine self-polishing, antifouling coating composition that has at least one biocidally active material, and a hydrolysable nonaqueous dispersion (NAD) polymer binder based on an alkyd stabilizer and acrylic core. The alkyd stabilizer can undergo hydrolysis and the acrylic core can undergo hydrolysis and hydration. The nonaqueous dispersion binder of this invention comprises at least one alkyd having a non-volatile materials content (NVM) greater than 90%, z-average molecular weight between about 10,000 and about 250,000 with a polydispersity between about 2.0 and about 20 as a dispersing medium for the polymerization of monomers to form a film forming resin comprising alkyd to acrylic ratios between 50/50 to 30/70. Two particularly suitable commercially available alkyds which exhibit the requisite Mz values and thus are suitable for use in this invention include the 98.5% solids, long oil alkyd marketed by Cargill, Inc. under the designation 57-5843 (Mz of approximately 45,000 and polydispersity of about 5.6). Another suitable alkyd is the 100% solids isophthalic alkyd oil marketed by McCloskey under the designation Varkydol® 210-100 (Mz of approximately 18,000 and polydispersity of about 2.7). The nonaqueous dispersion binders can also be prepared by the methods disclosed in U.S. Pat. No. 4,983,716 (Rao, et. al.) and U.S. Pat. No. 6,051,633 (Tomko, et. al.), incorporated herein by reference. The alkyd-stabilized nonaqueous dispersion can, for example, be based on a long oil alkyd or a medium oil alkyd based on soya or linseed fatty acid. The acrylic core can comprise a variety of monomers which can self-polish by hydration or hydrolysis. Such monomers include those with hydroxy, carboxy, acetoacetoxy, trimethylsilyl, tributylsilyl, triisopropysilyl, amine, pyrrolidinone, imidazole, and/or urea-functionality, and derivatives thereof. Examples of such monomers include hydroxyethylacrylate, hydroxyethylmethacrylate, hydroxypropylacrylate, hydroxypropylmethacrylate, acetoacetoxyethylacrylate, acetoacetoxyethylmethacrylate, methylacrylate, methylmethacrylate, methacryloxytrimethylsilane, methacryloxytripropylsilane, methacryloxytriisopropylsilane, methacryloxytributylsilane, methacryloxytriisobutylsilane, acrylic acid, tripropylsilane, triisopropylsilane, butylsilane, methacrylic acid, vinylpyrrolidinone, vinyl imidazole, dimethylaminoethylmethacrylate, dimethylaminomethacrylamide, and vinyl ethers, to name a few. Various combinations of the above functional monomers can be used to obtain different rates of self-polishing. Hydrolysis and hydration can be slowed or can be optimized by using hydrophobic materials like styrene, butylacrylate, butyl methacrylate, trifluoromethacrylate, 2-ethylhexylacrylate, branched vinyl esters, stearyl acrylate, stearyl methacrylate, lauryl acrylate, lauryl methacrylate, and so on. The Tg of the acrylic core can be varied to any desired value by proper combination of the monomers by procedures well-known to those skilled in the art.

The nonaqueous dispersions can be made with 50/50 to 30/70 ratio of the alkyd to acrylic, and the Tg's of the acrylic can range from 0° C. to 100° C. The nonaqueous dispersion can be up to 30% to about 70% by weight of the coating composition. Another method of adjusting hydrolysis and self-polishing rates is by blending in rosin-based materials, polyolefin-based copolymers, and styrene-based copolymers. The non-aqueous dispersions of this invention enables the resins to be prepared at very high solids of 80-90% by weight. This enables the paint formulations to be made at VOCs of less than 350 grams/liter, in compliance with VOC regulations.

The nonaqueous dispersion binder can be mixed with an effective amount of at least one biocidally active material that has antifouling activity. The biocidally active material can be a heavy metal free biocide. By this invention, a “heavy metal free biocide” means that the biocide is completely or substantially free of the metals copper, tin, antimony and arsenic, including the metal oxides such as cuprous oxide, tin oxide, antimony oxide, and arsenic oxide, and so on. The biocide can be used as the only biocide of the coating, or in combination with a co-biocide. The antifouling coating composition can comprise any combination of a variety of biocides, such as heavy metal free algaecides, fungicides, insecticides, molluscicides and bactericides. The biocides are used in such an amount that the proportion thereof in the solid contents of the coating composition is from about 0.1 to about 90% by weight, preferably from about 0.1 to about 80% by weight, and more preferably from about 1 to about 50% by weight.

The release of the active biocide material imparts the effective antifouling activity, and is dependent on the hydrolysis or self-polishing rate of the nonaqueous dispersion (NAD) binder delivery system. The NAD hydrolyzes in the seawater (at pH 8.0) at the proper rate so that a sufficient amount of the active biocide is present at the coating surface to continuously prevent barnacles and algae from attaching. Hydrolysis and self-polishing rates of the polymers can be determined by titration methods or by using a turboeroder which measures the rate of self-polishing over a period of time. Preferably, the extent of self-polishing measured by NAD hydrolysis is between about 20 mmol KOH/mol polymer to about 80 mmol KOH/mol polymer, and more preferably between about 40 mmol KOH/mol polymer to about 60 mmol KOH/mol polymer, as determined by titration methods.

Preferably, the biocides employed are degradable in seawater. For example, the antifouling coating composition can comprise one or more of about 2% by weight to about 20% by weight of a molluscicide based on 2-trihalogenmethyl-3-halogeno-4-cyanopyrrole derivatives and about 2% by weight to about 20% by weight of a cobiocide based on a variety of algaecides (phthalimides, sulfamides, triazines, oxathiazines, isothiazoline-3-ones, pyrithiones).

Examples of these metal-free organic compounds include N-trihalomethylthiophthalimides, trihalomethylthiosulfamides, dithiocarbamic acids, N-arylmaleimides, 3-(substituted amino)-1,3-thiazolidine-2,4-diones, dithiocyano compounds, triazine compounds, oxathiazines, and others.

Examples of the N-trihalomethylthiophthalimides include N-trichloromethylthiophthalimide and N-fluorodichloromethylthiophthalimide. Examples of the dithiocarbamic acids include bis(dimethylthiocarbamoyl) disulfide, ammonium N-methyldithiocarbamate and ammonium ethylene-bis(dithiocarbamate).

Examples of trihalomethylthiosulfamides include N-(dichlorofluoromethylthio)-N′,N′-dimethyl-N-phenylsulfamide and N-(dichlorofluoromethylthio)-N′,N′-dimethyl-N-(4-methylphenyl)sulfamide.

Examples of the N-arylmaleimides include N-(2,4,6-trichlorophenyl)maleimide, N-4-tolylmaleimide, N-3-chlorophenylmaleimide, N-(4-n-butylphenyl)maleimide, N-(anilinophenyl)maleimide, and N-(2,3-xylyl)maleimide.

Examples of the 3-(substituted amino)-1,3-thiazolidine-2,4-diones include 2-(thiocyanomethylthio)-benzothiazole, 3-benzylideneamino-1,3-thiazolidine-2,4-dione, 3-(4-methylbenzylideneamino)-1,3-thiazoline-2,4-dione, 3-(2-hydroxybenzylideneamino)-1,3-thiazolidine-2,4-dione, 3-(4-dimethylaminobenzylideneamino)-1,3-thiazolidine-2,4-dione, and 3-(2,4-dichlorobenzylideneamino)-1,3-thiazolidine-2,4-dione.

Examples of the dithiocyano compounds include dithiocyanomethane, dithiocyanoethane, and 2,5-dithiocyanothiophene.

Examples of the triazine compounds include 2-methylthio-4-t-butylamino-6-cyclopropylamino-s-triazine. Examples of oxathiazines include 1,2,4-oxathiazine and their mono- and di-oxides such as disclosed in PCT patent WSO 98/05719.

Other examples of the metal-free organic compounds include 2,4,5,6-tetrachloroisophthalonitrile, N,N-dimethyl-dichlorophenylurea, 4,5-dichloro-2-n-octyl-4-isothiazolin-3-one, N,N-dimethyl-N′-phenyl-(N-fluorodichloromethylthio)sulfamide, tetramethylthiouramdisulfide, 3-iodo-2-propinylbutyl carbamate, 2-(methoxycarbonylamino)benzimidazole, 2,3,5,6-tetrachloro-4-methylsulfonyl)pyridine, diiodomethyl-p-tolyl sulfone, 2-(4-thiazolyl)benzimidazole, and N-methylol formamide.

The self-polishing binders taught in this invention can also be used to formulate paints containing low amounts of cuprous oxide in conjunction with the heavy metal free biocides to obtain self-polishing antifouling paints with good protection from marine fouling.

The paint composition can also comprise one or more pigments that are not reactive with seawater and highly insoluble in seawater, such as titanium dioxide, talc or calcium carbonate. Such non-reactive and highly insoluble pigments can be used at up to 70 percent by weight of the total pigment component of the paint. The coating composition can additionally contain conventional solvent(s), thickener(s), stabilizer(s), pigment(s) or other additives.

The coating composition can be applied to any articles or surfaces that are to be protected, especially those that would come in contact with marine environment, such as various kinds of ship hulls (especially aluminum hulls), underwater structures, fish nets, ship bottoms, and others.

The invention is described further by the following examples which are intended to be illustrative and by no means limiting. All references to parts and percentages are by weight unless otherwise indicated.

### EXAMPLES

### Example 1A

### Preparation of ALKYD A

Charge 1871 grams of alkali refined soybean oil and 280.7 grams of trimelletic anhydride to a 4 liter round bottom flask under nitrogen purge and mechanical stirrer. Heat the contents to about 254° C. Hold at 254° C. for 1 hour and sample for Gardner viscosity of about D-E at 100% NVM and acid value greater than or equal to 75. Check sample for clarity. Cool to 175 C and charge 215.2 grams of trimethylol ethane and 72.4 grams of xylene, and heat to 249° C. After 1 hour at 249° C., check for Gardner viscosity of about W+ or greater and acid value less than 14. Drain Stark trap and increase nitrogen or perform sparge, or both, to remove residual xylene. Collect xylene in trap.

The resulting alkyd has a non-volatile materials content (NVM) of greater than or equal to 98% after xylene is removed, and a Gardner viscosity of about W-Y, and Gardner color of less than 14.

### Example 1B

### Preparation of ALKYD B

Charge 2016 grams of soya fatty acid, 549.7 grams pentaerythritol, 0.5 grams dibutyl tin, and 45.0 grams methylpropyl ketone to a 5 liter round bottom flask under nitrogen purge and mechanical stirrer. Heat the contents to about 370° C. Hold at 370° C. for 1 hour and add 392.0 grams crotonic acid, 554.1 grams isophthalic acid, 257.7 grams styrene-allyl alcohol copolymer (commercially available as RJ101, Lyondell Chemicals, Philadelphia, Pa.) and 45.00 grams methylpropyl ketone. Heat to 485° F. Hold for a viscosity of Z4 (maximum), acid value less than 20, and NVM of 97.5%. Cool. The resulting alkyd has a nonvolatile materials content (NVM) of about 98.2%.

### Example 2A

### Preparation of NAD Binder

In a 3-liter flask, heat charge of 186.6 grams mineral spirits and 192.2 grams of Alkyd A with nitrogen to 110° C. Add feed of 562 grams methyl methacrylate, 931.4 grams hydroxyethylacrylate, 8.1 grams 2-mercaptoethanol, 448 grams Alkyd A, 11.2 grams t-butyl peroctoate over three hours. Line wash with 37.8 grams mineral spirits. Hold for one hour. Charge 2 drops of vanadium 2-ethylhexate directly to reactor at end of hold. Chase with 75.9 grams mineral spirits, and 42.2 grams cumene hydroperoxide. Hold at 110° C. for 30 minutes, cool and transfer. The NAD has a viscosity of 2770 cps at room temperature and an NVM of about 86.6%.

### Example 2B

### Preparation of Antifouling Paint

The following formula was used to prepare an antifouling paint:

| | % by weight |
|---|---|
| NAD from Example 2A | 26.1 |
| Bentone 38 | 1.25 |
| Anti-Terra U Dispersant | 4.08 |
| Mineral Spirits | 18.5 |
| Calcium carbonate | 10.4 |
| Talc Miconized Flaky | 10.8 |
| Lo Micron Barytes | 16.7 |
| Precipitated Red Oxide | 2.76 |
| 2-trifluoromethyl-3-chloro-4-cyanopyrrole | 5.78 |
| N-(dichlorofluoromethylthio)-N′,N′-dimethyl- | 3.27 |
| N-(4-methylphenyl)sulfamide | |
| 12% Cobalt catalyst | 0.03 |
| 10% Calcium carboxylate | 0.14 |
| 18% Zirconium 2-ethylhexanoate | 0.09 |
| Dri-RX Drier 2,2′-Bipyridine | 0.05 |
| Methyl ethyl ketoxime | 0.04 |

### Example 3A

### Preparation of NAD Binder

In a 3-liter flask, heat charge of 252.8 grams mineral spirits and 283.6 grams of Alkyd A with nitrogen to 110° C. Add feed of 434.4 grams methyl methacrylate, 720.0 grams hydroxyethylacrylate, 6.27 grams 2-mercaptoethanol, 660.9 grams Alkyd A, 8.66 grams t-butyl peroctoate over three hours. Line wash with 37.1 grams mineral spirits. Hold for one hour. Charge 2 drops of vanadium 2-ethylhexate directly to reactor at end of hold. Chase with 58.7 grams mineral spirits, and 32.6 grams cumene hydroperoxide. Hold at 110° C. for 30 minutes, cool and transfer. The NAD has a viscosity of 1180 cps at room temperature and an NVM of about 83.2%.

### Example 3B

### Preparation of Antifouling Paint

The following formula was used to prepare an antifouling paint:

| | % by weight |
|---|---|
| NAD from Example 3A | 25.1 |
| Bentone 38 | 1.20 |
| Anti-Terra U Dispersant | 3.53 |
| Mineral Spirits | 15.41 |
| Calcium carbonate | 9.93 |
| Talc Miconized Flaky | 10.29 |
| Lo Micron Barytes | 16.00 |
| Precipitated Red Oxide | 2.63 |
| 2-trifluoromethyl-3-chloro-4-cyanopyrrole | 13.76 |
| 4,5-dichloro-2-n-octyl-4-isothiazolin-3-one | 11.03 |
| 12% Cobalt catalyst | 0.05 |
| 10% Calcium carboxylate | 0.19 |
| 18% Zirconium 2-ethylhexanoate | 0.13 |
| Dri-RX Drier 2,2′-Bipyridine | 0.06 |
| Methyl ethyl ketoxime | 0.06 |

### Example 4A

### Preparation of NAD Binder

In a 3-liter flask, heat charge of 157.7 grams mineral spirits and 196.2 grams of Alkyd B with nitrogen to 110° C. Add feed of 869.8 grams methyl methacrylate, 656.2 grams hydroxyethylacrylate, 8.2 grams 2-mercaptoethanol, 457 grams Alkyd B, 11.4 grams t-butyl peroctoate over three hours. Line wash with 40.0 grams mineral spirits. Hold for one hour. Charge 2 drops of vanadium 2-ethylhexate directly to reactor at end of hold. Chase with 60.0 grams mineral spirits, and 42.6 grams cumene hydroperoxide. Hold at 110° C. for 30 minutes, cool and transfer. The NAD has a viscosity of 6160 cps at room temperature and an NVM of about 82.4%.

### Example 4B

### Preparation of Antifouling Paint

The following formula was used to prepare an antifouling paint:

| | % by weight |
|---|---|
| NAD from Example 4A | 22.72 |
| Bentone 38 | 1.06 |
| Anti-Terra U Dispersant | 4.33 |
| Mineral Spirits | 18.47 |
| Calcium carbonate | 8.83 |
| Talc Miconized Flaky | 9.14 |
| Lo Micron Barytes | 14.22 |
| Precipitated Red Oxide | 2.34 |
| 2-trifluoromethyl-3-chloro-4-cyanopyrrole | 9.77 |
| N-(dichlorofluoromethylthio)-N′,N′-dimethyl- | 8.79 |
| N-(4-methylphenyl)sulfamide | |
| 12% Cobalt catalyst | 0.03 |
| 10% Calcium carboxylate | 0.11 |
| 18% Zirconium 2-ethylhexanoate | 0.08 |
| Dri-RX Drier 2,2′-Bipyridine | 0.04 |
| Methyl ethyl ketoxime | 0.03 |

### Example 5A

### Preparation of NAD Binder

In a 3-liter flask, heat charge of 169.1 grams mineral spirits and 290.9 grams of Alkyd A with nitrogen to 110° C. Add feed of 446.0 grams methyl methacrylate, 739.2 grams hydroxyethylacrylate, 6.44 grams 2-mercaptoethanol, 678.8 grams Alkyd A, 8.89 grams t-butyl peroctoate over three hours. Line wash with 36.9 grams mineral spirits. Hold for one hour. Charge 2 drops of vanadium 2-ethylhexate directly to reactor at end of hold. Chase with 71.6 grams mineral spirits, and 39.8 grams cumene hydroperoxide. Hold at 110° C. for 30 minutes, cool and transfer. The NAD has a viscosity of 5160 cps at room temperature and an NVM of about 82.6%.

### Example 5B

### Preparation of Antifouling Paint

The following formula was used to prepare an antifouling paint:

| | % by weight |
|---|---|
| NAD from Example 5A | 25.87 |
| Bentone 38 | 1.20 |
| Anti-Terra U Dispersant | 3.44 |
| Mineral Spirits | 9.71 |
| Calcium carbonate | 9.93 |
| Talc Miconized Flaky | 10.28 |
| Lo Micron Barytes | 15.99 |
| Precipitated Red Oxide | 2.63 |
| 2-trifluoromethyl-3-chloro-4-cyanopyrrole | 7.35 |
| N-(dichlorofluoromethylthio)-N′,N′-dimethyl- | 13.11 |
| N-(4-methylphenyl)sulfamide | |
| 12% Cobalt catalyst | 0.05 |
| 10% Calcium carboxylate | 0.19 |
| 18% Zirconium 2-ethylhexanoate | 0.13 |
| Dri-RX Drier 2,2′-Bipyridine | 0.06 |
| Methyl ethyl ketoxime | 0.06 |

### Example 6

### Preparation of an NAD Binder

In a 3-liter flask, heat charge of 186.2 grams mineral spirits and 264.7 grams of Alkyd A with nitrogen to 110° C. Add feed of 771.5 grams methyl methacrylate, 54.64 grams dimethylaminoacrylate, 266.6 grams hydroxyethylacrylate, 5.8 grams 2-mercaptoethanol, 629.2 grams Alkyd A, 8.19 grams t-butyl peroctoate over three hours. Line wash with 34.8 grams mineral spirits. Hold for one hour. Charge 2 drops of vanadium 2-ethylhexate directly to reactor at end of hold. Chase with 54.9 grams mineral spirits, and 30.5 grams cumene hydroperoxide. Hold at 110° C. for 30 minutes, cool and transfer. The NAD has a viscosity of 7700 cps at room temperature and an NVM of about 84.0%.

### Example 7

### Preparation of an NAD Binder

In a 3-liter flask, heat charge of 186.0 grams mineral spirits and 264.7 grams of Alkyd A with nitrogen to 110° C. Add feed of 434.3 grams methyl methacrylate, 109.3 grams methacrylic acid, 549.3 grams butylmethacrylate, 5.8 grams 2-mercaptoethanol, 629.2 grams Alkyd A, 8.20 grams t-butyl peroctoate over three hours. Line wash with 30.0 grams mineral spirits. Hold for one hour. Charge 2 drops of vanadium 2-ethylhexate directly to reactor at end of hold. Chase with 54.9 grams mineral spirits, and 30.5 grams cumene hydroperoxide. Hold at 110° C. for 30 minutes, cool and transfer. The NAD has an NVM of about 80.4%.

### Example 8

### Preparation of an NAD Binder

In a 3-liter flask, heat charge of 186.2 grams mineral spirits and 264.7 grams of Alkyd A with nitrogen to 110° C. Add feed of 748.6 grams methyl methacrylate, 54.6 grams N-vinyl imidazole, 289.6 grams hydroxyethylacrylate, 5.8 grams 2-mercaptoethanol, 629.2 grams Alkyd A, 8.19 grams t-butyl peroctoate over three hours. Line wash with 34.8 grams mineral spirits. Hold for one hour. Charge 2 drops of vanadium 2-ethylhexate directly to reactor at end of hold. Chase with 54.9 grams mineral spirits, and 30.2 grams cumene hydroperoxide over 45 minutes. Hold at 110° C. for 30 minutes, cool and transfer. The NAD has an NVM of about 84.0%.

### Example 9

### Preparation of an NAD Binder

In a 3-liter flask, heat charge of 164.6 grams mineral spirits and 229.1 grams of Alkyd B with nitrogen to 110° C. Add feed of 650.4 grams methyl methacrylate, 189.4 grams hydroxyethylacrylate, 46.7 grams acetoacetoxyethylmethacrylate, 5.07 grams 2-mercaptoethanol, 46.7 grams dimethylaminoethylmethacrylate, 534.5 grams Alkyd B, 7.0 grams t-butyl peroctoate over three hours. Line wash with 29.1 grams mineral spirits. Hold for one hour. Charge 2 drops of vanadium 2-ethylhexate directly to reactor at end of hold. Chase with 56.4 grams mineral spirits, and 31.4 grams cumene hydroperoxide. Hold at 110° C. for 30 minutes, cool and transfer. The NAD has an NVM of about 83.0%.

### Example 10

### Preparation of an NAD Binder

In a 3-liter flask, heat charge of 318.2 grams mineral spirits and 172.5 grams of Alkyd B with nitrogen to 110° C. Add feed of 943.5 grams methyl methacrylate,365.0 grams hydroxyethylacrylate, 68.9 grams methacryloxytrimethylsilane, 5.51 grams 2-mercaptoethanol, 977.4 grams Alkyd B, 7.16 grams t-butyl peroctoate over three hours. Line wash with 41.1 grams mineral spirits. Hold for one hour. Charge 2 drops of vanadium 2-ethylhexate directly to reactor at end of hold. Chase with 59.4 grams mineral spirits, and 33.1 grams cumene hydroperoxide for 45 minutes. Hold at 110° C. for 30 minutes, cool and transfer. The NAD has a viscosity of 2770 cps at room temperature and an NVM of about 85.0%.

### Example 11

### Preparation of an NAD Binder

In a 3-liter flask, heat charge of 186.2 grams mineral spirits and 264.7 grams of Alkyd A with nitrogen to 110° C. Add feed of 748.6 grams methyl methacrylate, 54.6 grams N-vinylpyrolidinone, 289.6 grams hydroxyethylacrylate, 5.8 grams 2-mercaptoethanol, 629.2 grams Alkyd A, 8.19 grams t-butyl peroctoate over three hours. Line wash with 34.8 grams mineral spirits. Hold for one hour. Charge 2 drops of vanadium 2-ethylhexate directly to reactor at end of hold. Chase with 54.9 grams mineral spirits, and 30.2 grams cumene hydroperoxide over 45 minutes. Hold at 110° C. for 30 minutes, cool and transfer. The NAD has an NVM of about 84.0%.

### Comparative Example

### Tin Control

The following formula was used to prepare a comparative example of an antifouling paint containing tin:

| | % by weight |
|---|---|
| Tin polymer (Biomet 304/60- | 32.84 |
| available from Atofina, Philadelphia, PA | |
| Zinc Oxide | 27.30 |
| Bentone 38 | 0.92 |
| Lo Micron Barytes | 6.63 |
| Precipitated Red Oxide | 2.60 |
| Lo Lo Tint 97, Copper Oxide | 20.06 |
| Methyl isobutylketone | 5.47 |
| Xylene | 4.19 |

Paint Examples 2B-5B were each applied to 6″×14″ (total immersion) and 6″×18″ (partial immersion) sandblasted steel panels prepared with two coats of anticorrosive epoxy primer and topcoated with two coats of antifouling paint. Each coat was applied at 2-3 mil dry film thickness. The painted panels were then immersed into tropic ocean waters for partial immersion evaluation and total immersion evaluation at recognized marine testing sites in India and Florida. After six months of tropical marine exposure, the partial immersion panels of Examples 2B, 3B, 4B and 5B give less than 10 barnacles/panel, and the total immersion panels of Examples 2B, 3B, 4B and 5B give less than 15 barnacles/panel. All of the test panels performed equal to or better than the heavy metal industry standard paint containing tin polymer. The following table illustrates the six-month data for test panels against the control:

### Six Month Marine Immersion Testing Data

| | Barnacle Count (# of barnacles) | | | | | |
|---|---|---|---|---|---|---|
| | 8 week | | 12 week | | 24 week | |
| | Partial | Total | Partial | Total | Partial | Total |
| Tin Control | 0 | 0 | 0 | 0 | 10.0 | 12.5 |
| Example 2B | 0 | 0 | 0 | 0 | 1.5 | 0 |
| Example 3B | 0 | 0 | 0 | 0 | 0 | 0 |
| Example 4B | 0 | 0 | 0 | 0 | 8.0 | 2.5 |
| Example 5B | 0 | 0 | 0 | 0 | 7.0 | 13.0 |

One year data of the same panels have barnacle counts less than 15.

1. A marine self-polishing antifouling coating composition comprising:
(a) at least one biocidally active material; and
(b) a polymer binder, wherein the polymer binder is a film-forming, alkyd-stabilized non-aqueous dispersion having an acrylic core.

2. The composition of claim 1, wherein the biocidally active material is free of heavy metals.

3. The composition of claim 1, wherein the polymer binder is a film forming resin comprising alkyd to acrylic ratios between about 50:50 to about 30:70.

4. The composition of claim 1, wherein the acrylic core has functionalities selected from the group consisting of hydroxy, carboxy, acetoacetoxy, trimethylsilyl, tributylsilyl, triisopropysilyl, amine, pyrrolidinone, imidazole, and/or urea-functionality, and derivatives or mixtures thereof.

5. The composition of claim 1, wherein the coating can self-polish in marine water.

6. The composition of claim 1, wherein the polymer binder has a self-polishing rate between about 20 mmol KOH/mol polymer and 80 mmol KOH/mol polymer.

7. The composition of claim 1, wherein the alkyd has a non-volatile materials content greater than 90%.

8. The composition of claim 1, wherein the metal-free biocide is degradable in seawater.

9. The composition of claim 6, wherein the metal-free biocide is selected from the group consisting of N-trihalomethylthiophthalimides, trihalomethylthiosulfamides, dithiocarbamic acids, N-arylmaleimides, 3-(substituted amino)-1,3-thiazolidine-2,4-diones, dithiocyano compounds, triazine compounds, oxathiazines, 2,4,5,6-tetrachloroisophthalonitrile, N,N-dimethyl-dichlorophenylurea, 4,5-dichloro-2-n-octyl-4-isothiazolin-3-one, N,N-dimethyl-N′-phenyl-(N-fluorodichloromethylthio)sulfamide, tetramethylthiouramdisulfide, 3-iodo-2-propinylbutyl carbamate, 2-(methoxycarbonylamino)benzimidazole, 2,3,5,6-tetrachloro-4-methylsulfonyl)pyridine, diiodomethyl-p-tolyl sulfone, 2-(4-thiazolyl)benzimidazole, and N-methylol formamide, and others.

10. The composition of claim 1, wherein the non-aqueous dispersion has a nonvolatile materials content greater than 75%.

11. The composition of claim 1, wherein the nonaqueous dispersion is formed from triglyceride oil.

12. The composition of claim 1, wherein the biocide is an algaecide, fungicide, insecticide, molluscicide, or bactericide.

13. The composition of claim 1, wherein the at least one biocide comprises a combination of a molluscicide and an algaecide.

14. The composition of claim 1, wherein the at least one biocide is selected from the group consisting of 2-trihalogenmethyl-3-halogeno-4-cyanopyrrole derivatives, N-(dichlorofluoromethylthio)-N′,N′-dimethyl-N-(4-methylphenyl)sulfamide, 4,5-dichloro-2-n-octyl-4-isothiazolin-3-one, and zinc pyrithione and mixtures thereof.

15. The composition of claim 1, wherein the barnacle count for total and partial immersion after six months on a 6″×14″ panel coated with said composition is less than 15.

16. A process for preparing an antifouling composition, comprising admixing (a) at least one biocidally active material and (b) a polymer binder, wherein the polymer binder is a film-forming, alkyd-stabilized non-aqueous dispersions having an acrylic core and a nonvolatile material contents greater than 75%.

17. An article resistant to marine fouling organisms, wherein said article comprises an antifouling coating applied to its surface, said antifouling coating comprising (a) at least one biocidally active material; and (b) a polymer binder, wherein the polymer binder is a film-forming, alkyd-stabilized non-aqueous dispersions having nonvolatile material contents greater than 75%.

18. The process of claim 14, wherein the surfaces or articles can be selected from the group consisting of aluminum hulls, underwater structures, fish nets, ship bottoms.
